(19) United States
(12) Patent Application Publication
(10) Pub. No.: US 2009/0315672 A1
(43) Pub. Date: Dec. 24, 2009

(54) METHOD OF PROGRAMMING A WIRELESS TRANSMITTER TO A WIRELESS RECEIVER

(75) Inventors: John Nantz, Brighton, MI (US); Mike Fawaz, Plymouth, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/141,310

(22) Filed: Jun. 18, 2008

(51) Int. Cl. G05B 19/04; G08C 19/00; H04L 9/12

(52) U.S. Cl. 340/5.26; 340/5.21

(57) ABSTRACT

A wireless remote control system includes a wireless receiver having a normal operating mode in which the wireless receiver may be actuated by a wireless transmitter programmed to the wireless receiver and a programming mode in which the receiver is placed to learn a new wireless transmitter and programming information for the new transmitter is sent to the wireless receiver. Programming a wireless transmitter to the wireless receiver includes actuating the receiver with an existing transmitter already programmed to the receiver, and repeating the actuation of the receiver in a predetermined sequence. In response to the receiver receiving the predetermined sequence of actuations, the receiver enters the programming mode. Programming information for the new transmitter is sent to the receiver, and the receiver programs the new transmitter to the receiver.

### BACKGROUND OF THE INVENTION

1. Field of the Invention

The invention relates to programming a wireless transmitter to a wireless receiver in a wireless remote control system of the type used to remotely control appliances such as garage door openers.

2. Background Art

Home appliances, such as garage door openers, security gates, home alarms, lighting, and the like, may conveniently be operated from a remote control. Typically, the remote control is purchased together with the appliance. The remote control transmits a radio frequency activation signal which is recognized by a receiver associated with the appliance. Aftermarket remote controls are gaining in popularity as such devices can offer functionality different from the original equipment's remote control. Such functionality includes decreased size, multiple appliance interoperability, increased performance, and the like. Aftermarket controllers are also purchased to replace lost or damaged controllers or to simply provide another remote control for accessing the appliance.

An example application for aftermarket remote controls are remote garage door openers integrated into an automotive vehicle. These integrated remote controls provide customer convenience, appliance interoperability, increased safety, and enhanced vehicle value. Present in-vehicle integrated remote controls provide a universal or programmable garage door opener which learns characteristics of an activation signal received from an existing transmitter then, when prompted by a user, generates a single activation signal having the same characteristics. One problem with such devices is the difficulty experienced by users in programming these devices. This is particularly true for rolling code receivers where the user must program both the in-vehicle remote control and the appliance receiver.

In a wireless remote control system of the type in which the user must program both the remote control and the appliance receiver (for example, garage door openers, gate openers, or barrier openers), existing practices for programming a wireless transmitter to the receiver require that the receiver be placed in a learn state before it will accept the new transmitter. The process for placing the receiver in the learn state usually includes pressing a button on the receiver itself. Usually the receiver is not easily accessible and, in the case of a garage door opener, can require the user to stand on a ladder to press the button. As well, the user will have limited time after pressing the button to go to the remote transmitter in the vehicle to continue the programming procedure before the learn state times out.

What is needed is a universal remote control that is easier to program. This remote control should be able to be integrated into an automotive vehicle using simple electronic circuits.

Background information may be found in U.S. Pat. Nos. 7,039,397 and 7,269,416, and U.S. Patent Application Publication Nos. 2002/0163440, 2003/0016119, 2004/0085185, 2004/0119581, 2004/0155793, 2004/0207537, 2005/0024228, and 2007/0096940.

### SUMMARY OF THE INVENTION

It is an object of the invention to provide an improved approach to programming a wireless transmitter to a wireless receiver which does not require that the user physically touch or access the receiver. Embodiments of the invention may be used in, for example, garage door openers, gate openers, or barrier openers, and the remote control unit may be integrated into an automotive vehicle. Other applications include unlocking/locking doors, windows, or other barriers, turning on or off lights, and arming or disarming security systems.

The invention comprehends a remote method of placing a wireless receiver into a learn mode for learning a new wireless transmitter with the same type of communication protocol and encryption. The contemplated methods are particularly useful for garage door openers.

In one embodiment, a wireless transmitter is programmed to a wireless receiver securely without physically accessing the receiver to place it into a learning mode. In more detail, an existing transmitter that is programmed to the wireless receiver is used to actuate the receiver. The receiver may be a receiver for a garage door opener. The actuation of the receiver with the known transmitter is repeated a predetermined number of times within a predetermined period of time.

When the receiver detects the existing wireless transmitter actuating the receiver for the predetermined number of times within the predetermined period of time, the receiver enters the learn state or programming mode. A visual or audible indication may optionally be given to the user to indicate that the receiver has in fact entered the programming mode. The receiver should remain in the programming mode for a predetermined period of time during which it can receive a new transmitter.

While the receiver is in the programming mode, the new transmitter programming information is sent to the receiver. In a preferred implementation, the original transmitter is used to again actuate the receiver to confirm that the new transmitter was intended to be programmed by the user. In such an implementation, the receiver should require the confirming actuation of the original transmitter within a predetermined period of time. When the receiver receives the confirming actuation from the original transmitter, a visual or audible indication may be given to the user, confirming that the receiver has learned the new transmitter.

There are many advantages associated with embodiments of the invention. In some embodiments of the invention, a wireless transmitter may be programmed to a rolling code (or fixed code) receiver of the type using encrypted modulation data. The wireless receiver may securely learn a new wireless transmitter with the same communication protocol and encryption technique without requiring manual access to the wireless receiver to place the wireless receiver into the learning mode. It is appreciated that the although one embodiment places the receiver into the learning or programming mode by actuating the existing wireless transmitter a predetermined number of times within a predetermined window of time, other techniques may be used to put the receiver in the programming mode without physical access.

For example, any other suitable predetermined sequence of transmissions from the existing transmitter may be used to enter programming mode. The required sequence should be something that would not be initiated unintentionally by the user. Since getting the receiver in the programming mode in embodiments of the invention requires physical possession of an existing transmitter, the required sequence should be something that would not occur unintentionally yet need not be so obscure that the user would be unable to remember the required sequence.

### BRIEF DESCRIPTION OF THE DRAWINGS

FIG. 1 illustrates a wireless remote control system according to an embodiment of the invention;

FIG. 2 illustrates a method of programming a wireless transmitter to a wireless receiver in the wireless remote control system according to an embodiment of the invention;

FIG. 3 is a schematic diagram illustrating activation signal characteristics which may be used in embodiments of the invention; and

FIG. 4 is a block diagram illustrating rolling code operation that may be used in embodiments of the invention.

### DETAILED DESCRIPTION OF THE PREFERRED EMBODIMENT

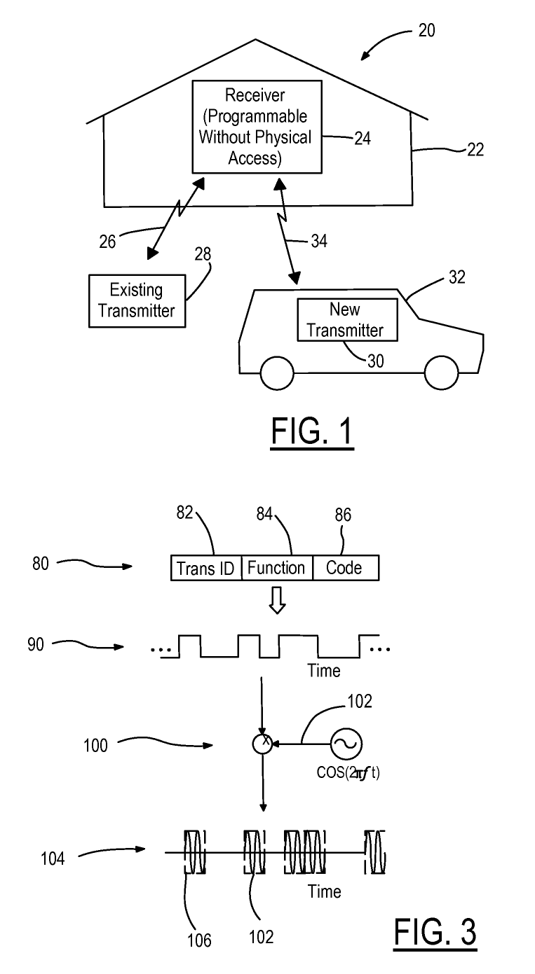

Referring to FIG. 1, a block diagram illustrating an appliance control system according to an embodiment of the invention is shown. An appliance control system, shown generally by 20, allows one or more appliances to be remotely controlled using radio transmitters. In the example shown, radio frequency remote controls are used to operate a garage door opener. However, the invention may be applied to controlling a wide variety of appliances such as other mechanical barriers, lighting, alarm systems, temperature control systems, and the like.

Appliance control system 20 includes garage 22 having a garage door, not shown. Garage door opener receiver 24 receives radio frequency control signals 26 for controlling a garage door opener. Activation signals have a transmission scheme which may be represented as a set of receiver characteristics. One or more existing transmitters 28 generate radio frequency activation signals 26 exhibiting the receiver characteristics in response to a user depressing an activation button.

A user of appliance control system 20 may wish to add a new transmitter to system 20. For example, a vehicle-based transmitter including programmable control 30 may be installed in vehicle 32, which may be parked in garage 22. Vehicle-based transmitter 30 generates a sequence of activation signals 34 which includes an activation signal having characteristics appropriate to activate garage door opener receiver 24. In the embodiment shown, programmable control 30 is mounted in vehicle 32. However, as will be recognized by one of ordinary skill in the art, the invention applies to universal remote controls that may also be hand-held, wall mounted, included in a key fob, and the like.

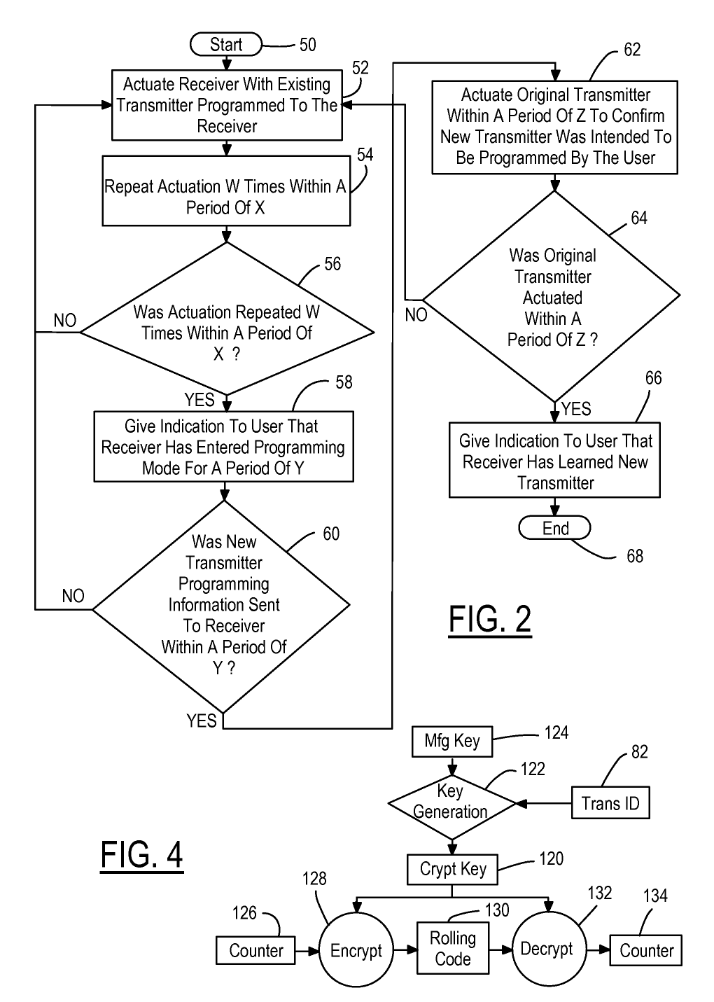

FIG. 2 illustrates a method of programming a wireless transmitter to a wireless receiver. In particular, new transmitter 30 in vehicle 32 is programmed to receiver 24. New transmitter 30 has a communication protocol and encryption technique which are compatible with receiver 24, but receiver 24 must be programmed to accept the new transmitter 30. As illustrated in this embodiment of the invention, receiver 24 is programmable without requiring physical access to receiver 24 by using existing transmitter 28 to place receiver 24 into its learning mode.

The method starts at block 50. Although particularly usable for a universal remote control which is integrated into an automotive vehicle using simple electronic circuits, embodiments of the invention are useful for other remote controls and for other appliances besides garage door openers.

The secure programming of new wireless transmitter 30 to receiver 24 begins by placing receiver 24 into programming or learning mode. Block 52 depicts the actuation of receiver 24 with existing transmitter 28 (which is already programmed to receiver 24). Block 54 depicts repeating the actuation with existing transmitter 28 for a total of W times within a period of X, for example, by pressing a button W times within X seconds. At decision block 56, receiver 24 checks to see if receiver 24 was actuated W times within a period of X. If not, flow returns to block 52 and receiver 24 does not enter the learning mode. If receiver 24 was actuated W times within a period of X, the receiver 24 enters the learning mode and a visual, audible, or other indication may be given to the user to convey that receiver 24 has entered its learning mode. Receiver 24 will remain in learning mode for a period of Y. (Block 58.)

At decision block 60, receiver 24 checks if new transmitter programming information was sent to receiver 24 within the receiver programming mode period of Y. If not, the receiver 24 leaves programming mode and flow returns to block 52. If receiver 24 receives new transmitter programming information from new transmitter 30, the original transmitter 28 is then actuated within a period of Z to confirm that new transmitter 30 was intended to be programmed by the user. (Block 62.) The confirming actuation may be a single actuation or a predetermined sequence of actuations.

At decision block 64, if the original transmitter 28 was not actuated to confirm programming of the new transmitter 30 within a period of Z, the programming operation is aborted and flow returns to block 52. If the confirming actuation is received, flow proceeds to block 66 and a visual, audible, or other indication may be given to the user to confirm that the receiver 24 has learned the new transmitter 30. Feedback to the user that the receiver has learned a new transmitter should take place for a predetermined period of time or take the form of a predetermined number of actuations. This is to ensure that if a new transmitter is learned to the receiver that an ample amount of time or actuations is allotted for the user to know the learning has taken place. The feedback could be, for example, a light flashing sequence, door operating sequence, etc. The programming process ends at block 68.

Put another way, in the example embodiment of the invention for programming a wireless transmitter to a wireless receiver described above, the user simply presses a button on existing transmitter 28 W times within a period of X to enter programming mode, presses a button on new transmitter 30, and presses the button on transmitter 28 to give confirmation. Thereafter, new transmitter 30 is programmed to receiver 24 and may be used in the same way as transmitter 28.

It is appreciated that although FIGS. 1 and 2 illustrate placing the receiver 24 into the learning or programming mode by actuating the existing wireless transmitter 28 a predetermined number of times within a predetermined window of time, other techniques may be used to put the receiver 24 in the programming mode without physical access. For example, any other suitable predetermined sequence of transmissions from the existing transmitter 28 may be used to enter programming mode. The required sequence should be something that would not be initiated unintentionally by the user, but should be something simple enough for the user to easily place the receiver 24 in learning mode when desired. For example, the sequence may be pressing the button 5 times in a period of 10 seconds. Or, the sequence may be pressing the button 3 times quickly, pausing for 2-5 seconds, and then again pressing the button 3 times quickly. Because getting the receiver in the programming mode requires physical possession of an existing transmitter, the sequence need not be overly complicated. However, a more complicated sequence may be used if desired.

For example, the illustrated embodiment includes a series of actuations from the existing transmitter 28 followed by a single indication from the receiver 24 that the receiver 24 has entered programming mode, that is, a single step authentication. In an alternative, a multiple step authentication could be used. For example a simple sequence of button presses on the existing transmitter 28, an indication from the receiver 24, a second simple sequence of button presses on the existing transmitter 28, and then the receiver 24 enters programming mode.

It is appreciated that embodiments of the invention are suitable for fixed code or rolling code operation. With a new fixed code transmitter, the receiver may be programmed with the fixed code. With a new rolling code transmitter, the receiver may synchronize with the new transmitter.

Referring to FIG. 3, a schematic diagram illustrating activation signal characteristics according to an embodiment of the invention is shown. Information transmitted in an activation signal is typically represented as a binary (or trinary) data word, shown generally by 80. Data word 80 may include one or more fields, such as transmitter identifier 82, function indicator 84, code word 86, and the like. Transmitter identifier (TRANS ID) 82 uniquely identifies a remote control transmitter. Function indicator 84 indicates which of a plurality of functional buttons on the remote control transmitter were activated. Code word 86 helps to prevent misactivation and unauthorized access.

Several types of codes 86 are possible. One type of code is a fixed code, wherein each transmission from a given remote control transmitter contains the same code 86. In contrast, variable code schemes change the bit pattern of code 86 with each activation. The most common variable code scheme, known as rolling code, generates code 86 by encrypting a synchronization (sync) counter value. After each activation, the counter is incremented. The encryption technique is such that a sequence of encrypted counter values appears to be random numbers.

Data word 80 is converted to a baseband stream, shown generally by 90, which is an analog signal typically transitioning between a high voltage level and a low voltage level. Multilevel transmissions are also possible. Various baseband encoding or modulation schemes are known.

Baseband stream 90 is converted to a radio frequency signal through a modulation process shown generally by 100. Baseband stream 90 is used to modulate one or more characteristics of carrier 102 to produce a broadband signal, shown generally by 104. Modulation process 100, mathematically illustrated by multiplication in FIG. 3, implements a form of amplitude modulation commonly referred to as on-off keying. As will be recognized by one of ordinary skill in the art, many other modulation forms are possible, including frequency modulation, phase modulation, and the like. In the example shown, baseband stream 90 forms envelope 106 modulating carrier 102.

It is appreciated that the activation signal characteristics shown in FIG. 3 are exemplary, and any suitable activation signals may be used for the remote transmitter units. More specifically, methods of the invention for programming a wireless transmitter to a wireless receiver are not limited to any particular activation signal characteristics and the illustration in FIG. 3 is only provided to facilitate understanding of operation of a remote control system.

Referring to FIG. 4, a block diagram illustrating rolling code operation that may be used with the invention is shown. Remotely controlled systems using rolling code require crypt key 120 in both the transmitter and the receiver for normal operation. In a well-designed rolling code scheme, crypt key 120 is not transmitted from the transmitter to the receiver. Typically, crypt key 120 is generated using key generation algorithm 122 based on transmitter identifier 82 and a manufacturing (MFG) key 124. Crypt key 120 and transmitter identifier 82 are then stored in a particular transmitter. Counter 126 is also initialized in the transmitter. Each time an activation signal is sent, the transmitter uses encrypt algorithm 128 to generate rolling code value 130 from counter 126 using crypt key 120. The transmitted activation signal includes rolling code 130 and transmitter identifier 82.

A rolling code receiver is trained to a compatible transmitter prior to normal operation. The receiver is placed into a learn mode. Upon reception of an activation signal, the receiver extracts transmitter identifier 82. The receiver then uses key generation algorithm 122 with manufacturing key 124 and received transmitter identifier 82 to generate crypt key 120 identical to the crypt key used by the transmitter. Newly generated crypt key 120 is used by decrypt algorithm 132 to decrypt rolling code 130, producing counter 134 equal to counter 126. The receiver then saves counter 134 and crypt key 120 associated with transmitter identifier 82. As is known in the encryption art, encrypt algorithm 128 and decrypt algorithm 132 may be the same algorithm.

In normal operation, when the receiver receives an activation signal, the receiver first extracts transmitter identifier 82 and compares transmitter identifier 82 with all learned transmitter identifiers. If no match is found, the receiver rejects the activation signal. If a match is found, the receiver retrieves crypt key 120 associated with received transmitter identifier 82 and decrypts rolling code 130 from the received activation signal. If the received counter matches counter 134 associated with transmitter identifier 82, activation proceeds.

Another rolling code scheme generates crypt key 120 based on manufacturing key 124 and a seed or random number. An existing transmitter sends this seed to an appliance receiver when the receiver is placed in learn mode. The transmitter typically has a special mode for transmitting the seed that is entered, for example, by pushing a particular combination of buttons. The receiver uses the seed to generate crypt key 120. As will be recognized by one of ordinary skill in the art, the invention applies to the use of a seed for generating a crypt key as well as to any other variable code scheme.

It is appreciated that the above discussion of rolling code operation is exemplary, and various operating techniques may be used. More specifically, methods of the invention for programming a wireless transmitter to a wireless receiver are not limited to any particular operation technique and the above description is provided as an example to facilitate understanding of operation of a remote control system. Embodiments of the invention relate to the approach to programming a new wireless transmitter to the wireless receiver, and operation particulars may vary. That is, the invention relates to the way that the receiver is placed into the learn mode, and is independent of any particular operating technique.

There are many advantages associated with embodiments of the invention. In embodiments of the invention, a wireless receiver may securely learn a new wireless transmitter with the same communication protocol and encryption technique without requiring manual access to the wireless receiver to place the wireless receiver into the learning mode. Embodiments of the invention may involve fixed or rolling code transmitters, and may operate in any suitable way. In accordance with the invention, the receiver may be placed in the learn mode without physical access to the receiver to allow the transmitter information (for example, transmitter identification, seed value, fixed code value, etc.) to be learned by the receiver.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of programming a wireless transmitter to a wireless receiver in a wireless remote control system, the wireless receiver having a normal operating mode in which the wireless receiver may be actuated by a wireless transmitter programmed to the wireless receiver and a programming mode in which the receiver is placed to learn a new wireless transmitter and programming information for the new transmitter is sent to the wireless receiver, the method comprising:
actuating the receiver with an existing transmitter already programmed to the receiver;
repeating the actuation of the receiver in a predetermined sequence;
in response to the receiver receiving the predetermined sequence of actuations, the receiver entering the programming mode;
sending programming information for the new transmitter to the receiver; and
the receiver programming the new transmitter to the receiver.

2. The method of claim 1 wherein repeating the actuation of the receiver in the predetermined sequence comprises:
actuating the receiver with the existing transmitter a predetermined number of times within a predetermined period of time.

3. The method of claim 1 further comprising:
upon entering the programming mode, giving an indication to the user that the receiver has entered the programming mode

4. The method of claim 1 further comprising:
after sending the programming information for the new transmitter, actuating the existing transmitter to confirm the new transmitter was intended to be programmed by the user.

5. The method of claim 1 further comprising:
upon receiving the programming information for the new transmitter, giving an indication to the user that the receiver has learned the new transmitter.

6. The method of claim 1 wherein the programming information for the new transmitter indicates a fixed code.

7. The method of claim 1 wherein the programming information for the new transmitter indicates a transmitter identification for a rolling code.

8. The method of claim 1 wherein the programming information for the new transmitter indicates a seed value for a rolling code.

9. A wireless remote control system comprising:
a wireless receiver having a normal operating mode in which the wireless receiver may be actuated by a wireless transmitter programmed to the wireless receiver and a programming mode in which the receiver is placed to learn a new wireless transmitter and programming information for the new transmitter is sent to the wireless receiver;
at least one wireless transmitter; and
wherein the receiver is configured to operate such that programming a wireless transmitter to the wireless receiver comprises:
actuating the receiver with an existing transmitter already programmed to the receiver;
repeating the actuation of the receiver in a predetermined sequence;
in response to the receiver receiving the predetermined sequence of actuations, the receiver entering the programming mode;
sending programming information for the new transmitter to the receiver; and
the receiver programming the new transmitter to the receiver.

10. The system of claim 9 wherein repeating the actuation of the receiver in the predetermined sequence comprises:
actuating the receiver with the existing transmitter a predetermined number of times within a predetermined period of time.

11. The system of claim 9 wherein programming the wireless transmitter to the wireless receiver further comprising:
upon entering the programming mode, giving an indication to the user that the receiver has entered the programming mode.

12. The system of claim 9 wherein programming the wireless transmitter to the wireless receiver further comprising:
after sending the programming information for the new transmitter, actuating the existing transmitter to confirm the new transmitter was intended to be programmed by the user.

13. The system of claim 9 wherein programming the wireless transmitter to the wireless receiver further comprising:
upon receiving the programming information for the new transmitter, giving an indication to the user that the receiver has learned the new transmitter.

14. The system of claim 9 wherein the programming information for the new transmitter indicates a fixed code.

15. The system of claim 9 wherein the programming information for the new transmitter indicates a transmitter identification for a rolling code.

16. The system of claim 9 wherein the programming information for the new transmitter indicates a seed value for a rolling code.

17. The system of claim 9 wherein the remote control system controls a barrier.

18. The system of claim 9 wherein the remote control system controls a lighting system.

19. The system of claim 9 wherein the remote control system controls a security system.

20. A wireless remote control system comprising:
a wireless receiver having a normal operating mode in which the wireless receiver may be actuated by a wireless transmitter programmed to the wireless receiver and a programming mode in which the receiver is placed to learn a new wireless transmitter and programming information for the new transmitter is sent to the wireless receiver;
wherein the receiver is configured to operate such that programming a wireless transmitter to the wireless receiver comprises:
actuating the receiver with an existing transmitter already programmed to the receiver;
repeating the actuation of the receiver in a predetermined sequence;
in response to the receiver receiving the predetermined sequence of actuations, the receiver entering the programming mode;
sending programming information for the new transmitter to the receiver; and
the receiver programming the new transmitter to the receiver.
